(19) United States
(12) Patent Application Publication
(10) Pub. No.: US 2007/0291695 A1
(43) Pub. Date: Dec. 20, 2007

(54) METHOD AND APPARATUS FOR FACILITATING LOSSLESS HANDOVER IN 3GPP LONG TERM EVOLUTION SYSTEMS

(75) Inventors: Mohammed Sammour, Montreal (CA); Arty Chandra, Manhasset Hills, NY (US); Narayan Parappil Menon, Syosset, NY (US); Ulises Olvera-Hernandez, Kirkland (CA); James M. Miller, Verona, NJ (US); Maged M. Zaki, San Diego, CA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/741,930

(22) Filed: Apr. 30, 2007

Related U.S. Application Data
(60) Provisional application No. 60/796,484, filed on May 1, 2006.
(60) Provisional application No. 60/866,473, filed on Nov. 20, 2006.

(51) Int. Cl. H04Q 7/00

(52) U.S. Cl. 370/331

(57) ABSTRACT

The present invention is related to a method and apparatus for facilitating lossless handover in a wireless communication system comprising at least one wireless transmit/receive unit (WTRU), a source evolved Node B (eNB), a target eNB, and a mobility management entity/user plane entity (MME/UPE) where the WTRU is in wireless communication with the source eNB. The source eNB determines to handover the WTRU to the target eNB, requests status reports from the WTRU, and requests handover to the target eNB. The handover request includes context information relating to the WTRU which is sent to the target eNB. The target eNB configures resources for the WTRU and transmits a handover response signal to the source eNB. The source eNB commands the WTRU to perform a handover to the target eNB and forwards data to the target eNB. The WTRU performs the handover to the target eNB.

### CROSS REFERENCE TO RELATED APPLICATIONS

This application claims the benefit of U.S. Provisional Application No. 60/796,484, filed May 1, 2006 and U.S. Provisional Application No. 60/866,473, filed Nov. 20, 2006, both of which are incorporated herein by reference as if fully set forth.

### FIELD OF INVENTION

The present invention is related to handover in a third generation partnership (3GPP) long term evolution (LTE) system. More particularly, the present invention is related to a method and apparatus for facilitating lossless handover in a 3GPP LTE system.

### BACKGROUND

Signaling flows for handover have been considered by the 3GPP LTE working group, but there is no method has been proposed yet to avoid data loss during the handover. FIG. 1 is an exemplary prior art signal diagram 100 of handover signaling. The 3GPP test specification group (TSG)-radio access network (RAN) working group 3 (WG3) document R3-060440 highlighted the fact that there are two options for handling lossless handover, but each of them has deficiencies.

Unlike in a conventional universal mobile telecommunications system (UMTS), in a long term evolution (LTE) system, automatic repeat request (ARQ) and segmentation are located in an evolved Node-B (eNB) while packet data convergence protocol (PDCP) is in a gateway (GW). As an example, PDCP functions can be executed in an GW, an RNC or a combination of the two. If data forwarding from a source eNB to a target eNB is applied, the type of data that should be forwarded will need to be determined, such as whether the data should be forwarded before segmentation or after segmentation.

In the first case, a radio link control (RLC) service data unit (SDU), (PDCP protocol data unit (PDU)), is forwarded as in the conventional UMTS. RLC SDUs refer to the SDUs that have not been confirmed. In the second case, both RLC SDUs and RLC PDUs are forwarded. Also in the second case, an RLC SDU indicates that the SDUs that have not been segmented and the RLC PDU indicates a data packet that has been segmented and contains added header information.

Table 1 below shows some of the advantages and disadvantages of both the first and second cases:

TABLE 1

| | | Both RLC SDU and RLC |
|---|---|---|
| | RLC SDU is forwarded | PDU are forwarded |
| Disadvantages | Wasted radio resources | New mechanism to |
| | because if one of RLC | transmit both PDU |
| | PDU is not confirmed, | and SDU. |
| | a complete RLC SDU | |
| | will be transmitted | |
| | again. | |
| Advantages | No data loss. | No data loss |
| | Comply with the current | Efficient use of |
| | mechanism. | radio resources. |
| | Easy for data forwarding. | |

FIG. 2 is a functional block diagram of a prior art evolved-UTRAN (E-UTRAN) protocol stack 200. The protocol stack 200 includes a plurality of layers for various functions. Although not shown, PDCP functionality may also exist in the eNB.

For example, a PDCP sub-layer performs functions such as header compression. PDCP SDUs (service data units) are input into the PDCP sub-layer, and PDCP PDUs are output and sent to an RLC sub-layer. The PDCP PDUs are viewed as RLC SDUs, from the perspective of the RLC sub-layer.

In the RLC sub-layer, RLC SDUs are input, and RLC PDUs are output. The RLC layer performs functions such as:
Error correction through ARQ: a retransmission mechanism used to improve the reliability of packet delivery through identifying missing packets and retransmitting them, thereby reducing the residual packet error rate. Some applications may bypass the Error correction functionality of the RLC sub layer. These packets are sent via unacknowledged mode RLC with no error recovery.
Reordering: The RLC receive side sublayer reorders the packets before forwarding to a higher layer.
Segmentation: an RLC SDU can be broken up into multiple ‘smaller’ RLC PDUs, whose size can be linked to, or dependent on, the size of the transport block (TB). The RLC segment size is not necessarily a constant, meaning that RLC PDUs may be of varying sizes.
Resegmentation: when necessary for retransmission, (e.g., when the radio quality such as the supported TB size changes).
Concatenation (FFS): multiple ‘small’ RLC SDUs can be concatenated to form a single RLC PDU.

A MAC sub-layer contains a Hybrid ARQ (HARQ) function. There are currently various proposals for “HARQ assisted ARQ”, whereby the ARQ function at the RLC is assisted by HARQ. For instance, the HARQ transmitter (Tx) can generate local acknowledgement (ACK) or local negative ACK (NACK) messages to the RLC transmitter, instead of, or in addition to relying on acknowledgement messages coming from the RLC receiver (Rx) to the RLC Tx.

RLC PDU's are sometimes referred to as RLC ‘segments’, since segmentation is a function of the RLC sub-layer. Additionally, the RLC ARQ retransmission functionality can apply at either the RLC SDU level or the RLC PDU level.

At the RLC SDU level, a loss of any PDU that belongs to an SDU implies that the whole SDU will need to be retransmitted by the RLC Tx side. At the RLC PDU level, a loss of a PDU implies that only such PDU will need to be retransmitted by the RLC Tx side.

In the current 3GPP UTRAN, the RLC PDUs are of fixed size, and the ARQ retransmission functionality operates at the RLC PDU level as opposed to the SDU level. To be able to identify the missing PDUs and retransmit them, the RLC PDUs are numbered by the RLC Tx using a sequence numbers (SN) that is incremented every PDU. The RLC Rx keeps track of which PDU SNs are received and which are not, and sends the information to the RLC Tx using what is typically referred to as an acknowledgement status PDU.

The following terms apply throughout:
“RLC Tx Context” refers to any context information (or state information or variables) that are used by the RLC Tx side.
“RLC Rx Context” refers to any context information (or state information or variables) that are used by the RLC Rx side.
“RLC Configuration Context” refers to any parameters that are needed to configure the RLC Tx and/or the RLC Rx.
“RLC Context” refers to any or all of “RLC Tx Context” and/or “RLC Rx Context” and/or “RLC Configuration Context”.

The RLC Tx side is the Node B (NB) for the downlink traffic case, and is the user equipment (UE), or wireless transmit/receive unit (WTRU) for the uplink traffic case. Correspondingly, the RLC Rx side is the UE for the downlink traffic case, and is the NB for the uplink traffic case.

According to 3GPP R6 RLC protocol specification, the RLC Tx Context includes the following state variables that are maintained in the Sender (Transmitter):
VT(S)—Send state variable. This state variable contains the “Sequence Number” of the next AMD PDU to be transmitted for the first time, (i.e., excluding retransmitted PDUs).

VT(A)—Acknowledge state variable. This state variable contains the “Sequence Number” following the “Sequence Number” of the last in-sequence acknowledged AMD PDU. This forms the lower edge of the transmission window of acceptable acknowledgements.
VT(DAT). This state variable counts the number of times a AMD PDU has been scheduled to be transmitted. There shall be one VT(DAT) for each PDU and each shall be incremented every time the corresponding AMD PDU is scheduled to be transmitted.
VT(MS)—Maximum Send state variable. This state variable contains the “Sequence Number” of the first AMD PDU that can be rejected by the peer Receiver, VT(MS)=VT(A)+VT(WS). This value represents the upper edge of the transmission window. The transmitter shall not transmit AMD PDUs with “Sequence Number”>=VT(MS) unless VT(S)>=VT(MS). In that case, the AMD PDU with “Sequence Number”=VT(S) —1 can also be transmitted. VT(MS) shall be updated when VT(A) or VT(WS) is updated.
VT(US)—UM data state variable. This state variable contains the “Sequence Number” of the next UMD PDU to be transmitted.
VT(PDU). This state variable is used when the “poll every Poll_PDU PDU” polling trigger is configured.
VT(SDU). This state variable is used when the “poll every Poll_SDU SDU” polling trigger is configured.
VT(RST)—Reset state variable. This state variable is used to count the number of times a RESET PDU is scheduled to be transmitted before the reset procedure is completed.
VT(MRW)—MRW command send state variable. This state variable is used to count the number of times a MRW command is transmitted.
VT(WS)—Transmission window size state variable. This state variable contains the size that shall be used for the transmission window. VT(WS) shall be set equal to the WSN field when the transmitter receives a status PDU including a WINDOW SUFI. The initial value of this variable is Configured_Tx_Window_size.
Timers—such as Timer_Discard, Timer_Poll_Prohibit, Timer_Poll_Periodic, Timer_RST, Timer_MRW, and the like.

Again, according to 3GPP R6 RLC protocol specification, the RLC Rx Context includes the following state variables that are maintained in the Receiver:
VR(R)—Receive state variable. This state variable contains the “Sequence Number” following that of the last in-sequence AMD PDU received. It shall be updated upon the receipt of the AMD PDU with “Sequence Number” equal to VR(R).
VR(H)—Highest expected state variable. This state variable contains the “Sequence Number” following the highest “Sequence Number” of any received AMD PDU. When a AMD PDU is received with “Sequence Number” x such that VR(H)<=x<VR(MR), this state variable shall be set equal to x+1.
VR(MR)—Maximum acceptable Receive state variable. This state variable contains the “Sequence Number” of the first AMD PDU that shall be rejected by the Receiver, VR(MR)=VR(R)+Configured_Rx_Window_Size.
VR(US)—Receiver Send Sequence state variable. This state variable is applicable only when “out of sequence SDU delivery” is not configured. This state variable contains the “Sequence Number” following that of the last UMD PDU received by the reception buffer. When a UMD PDU with “Sequence Number” equal to x is received by the reception buffer, the state variable shall set equal to x+1.
VR(UOH)—UM out of sequence SDU delivery highest received state variable. This state variable contains the “Sequence Number” of the highest numbered UMD PDU that has been received.
VR(UDR)—UM duplicate avoidance and reordering send state variable. This state variable contains the “Sequence Number” of the next UMD PDU that is expected to be received in sequence.
VR(UDH)—UM duplicate avoidance and reordering highest received state variable. This state variable contains the “Sequence Number” of the highest numbered UMD PDU that has been received by the duplicate avoidance and reordering function.
VR(UDT)—UM duplicate avoidance and reordering timer state variable. This state variable contains the sequence number of the UMD PDU associated with Timer_DAR when the timer is running.
VR(UM)—Maximum acceptable Receive state variable. This state variable contains the “Sequence Number” of the first UMD PDU that shall be rejected by the Receiver, VR(UM)=VR(US)+Configured_Rx_Window_Size. This state variable is only applicable when out-of-sequence reception is configured by higher layers.
Timers—such as Timer_Status_Prohibit, Timer_Status_Periodic, Timer_OSD, Timer_DAR, and the like.

The 3GPP R6 RLC Configuration Context may include various protocol parameters such as window sizes and maximum number of transmissions, and the like. Examples from R6 RLC include Configured_Tx_Window_Size, Configured_Rx_Window_Size, MaxDAT, Poll_PDU, Poll_SDU. Poll_Window, MaxRST, MaxMRW, OSD_Window_Size, DAR Window_Size.

Furthermore, there is a dynamic interaction between the RLC Tx Context and the RLC Rx Context, mainly through status messages such as signals or PDUs that are mainly used to update the RLC Tx Context based on the latest RLC Rx context. For example, the status can contain positive ACKs for PDU SNs that have been correctly received by the RLC Rx, and NACKs for PDU sequence numbers that have not been correctly received by the RLC Rx. Such acknowledgement status information is used by the RLC Tx to update its context, such as VT(A), the acknowledge state variable, for example.

In a HARQ assisted ARQ scheme, there is a dynamic interaction between the local ACK or local NACK messages generated by the HARQ Tx and the RLC Tx Context. Such local ACK/NACK messages can convey similar information to that contained within the status messages, but in a more timely or responsive manner.

However, there is not provision for achieving a lossless handover in a 3GPP LTE system. To achieve lossless handover in an efficient manner in 3GPP LTE systems or evolved FDD HSPA systems, RLC Context information will need to be collected from the source NB to target NB in a timely and efficient manner, translated or mapped into efficient and detailed “Context Transfer Signals or Messages” that are sent between source and target NB's, and synchronized or aligned between the target and source NBs.

Accordingly, it would be beneficial to provide a method and apparatus for facilitating lossless handover in a 3GPP LTE system.

### SUMMARY

The present invention is related to a method and apparatus for facilitating lossless handover in a wireless communication system comprising at least one wireless transmit/receive unit (WTRU), a source evolved Node B (eNB), a target eNB, and a mobility management entity/user plane entity (MME/UPE) where the WTRU is in wireless communication with the source eNB. The source eNB determines to handover the WTRU to the target eNB, requests status reports from the WTRU, and requests handover to the target eNB. The handover request includes context information relating to the WTRU which is sent to the target eNB. The target eNB configures resources for the WTRU and transmits a handover response signal to the source eNB. The source eNB commands the WTRU to perform a handover to the target eNB and forwards data to the target eNB. The WTRU performs the handover to the target eNB.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is an exemplary prior art signal diagram of handover signaling;

FIG. 2 is a functional block diagram of a prior art E-UTRAN protocol stack;

FIG. 3 shows an exemplary wireless communication system, including a wireless transmit/receive unit (WTRU) and a plurality of eNBs, configured in accordance with the present invention;

FIG. 4 is a functional block diagram of a WTRU and eNB of the wireless communication system of FIG. 3;

FIG. 5A shows an exemplary SDU including PDUs having less often status reporting;

FIG. 5B shows an exemplary SDU including PDUs having more often status reporting;

FIGS. 6A and 6B show an exemplary signal diagram of a WTRU, source eNB, target eNB, and MME/UPE performing a method for facilitating lossless handover in the wireless communication system of FIG. 3 in accordance with the present invention;

FIGS. 7A and 7B show an exemplary signal diagram of a WTRU, source eNB, target eNB, and MME/UPE performing another method for facilitating lossless handover in the wireless communication system of FIG. 3 in accordance with the present invention;

FIGS. 8A and 8B show an exemplary signal diagram of a WTRU, source eNB, target eNB, and MME/UPE performing another method for facilitating lossless handover in the wireless communication system of FIG. 3 in accordance with the present invention; and

FIGS. 9A and 9B show an exemplary signal diagram of a WTRU, source eNB, target eNB, and MME/UPE performing another method for facilitating lossless handover in the wireless communication system of FIG. 3 in accordance with the present invention.

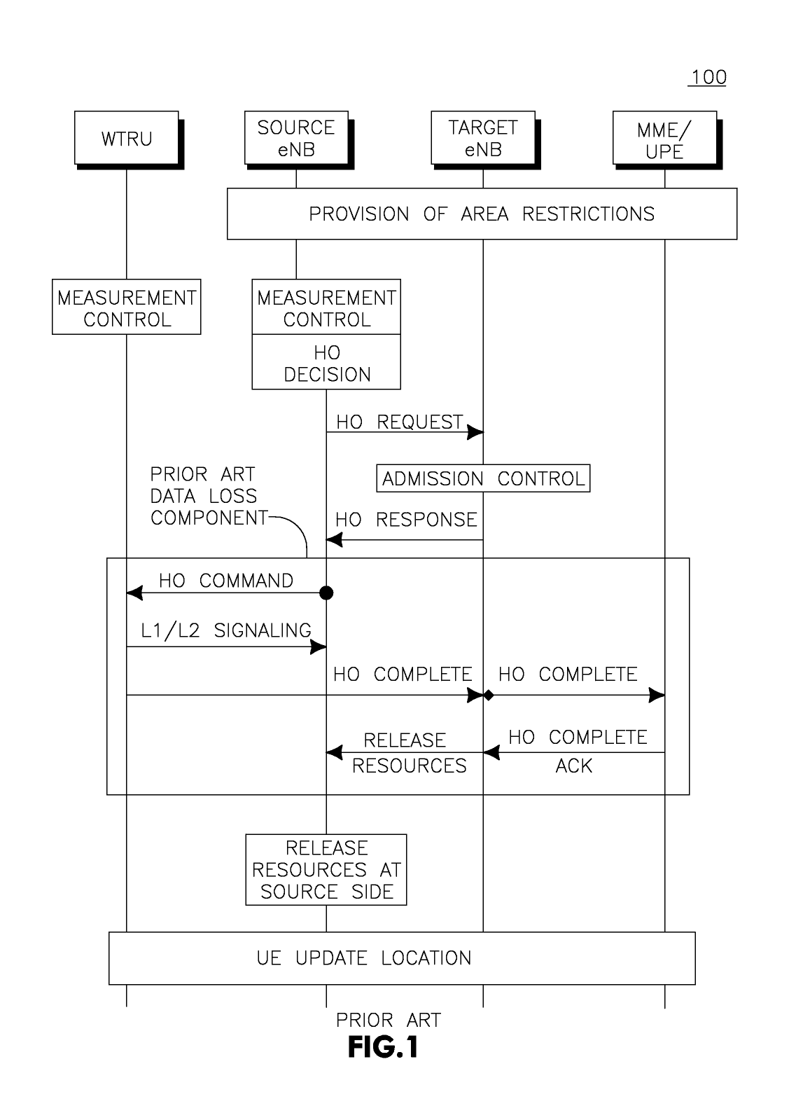

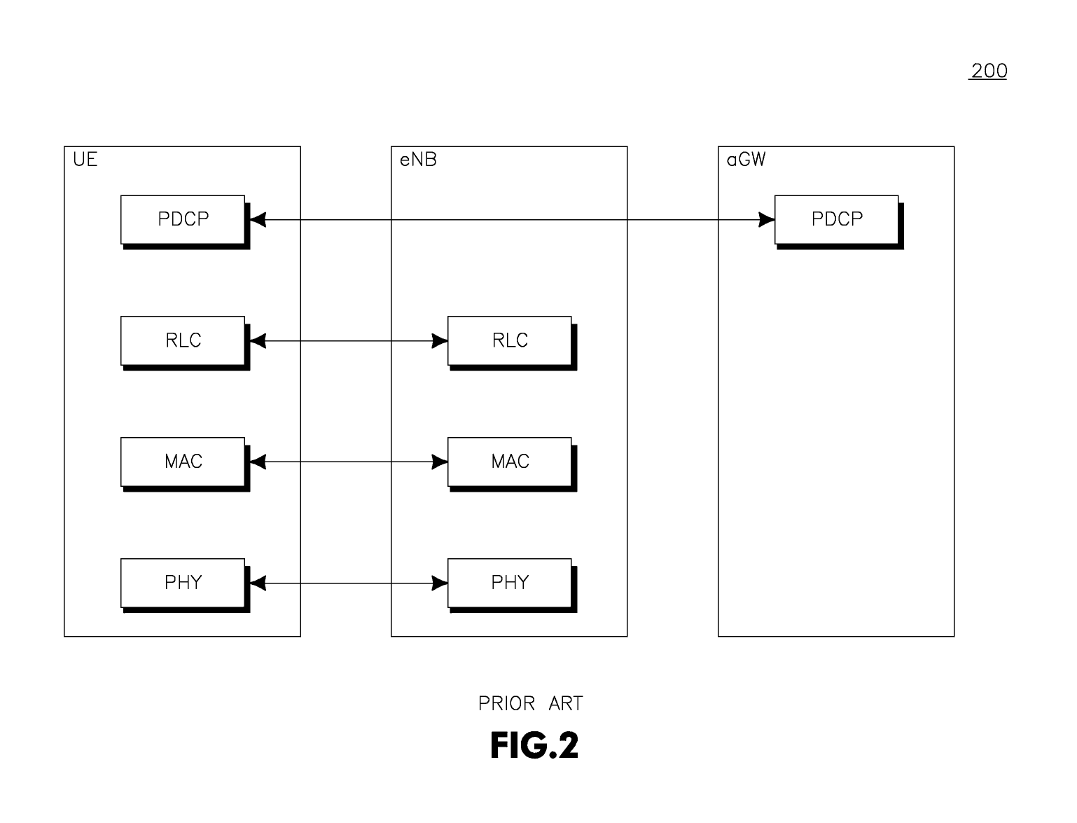

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

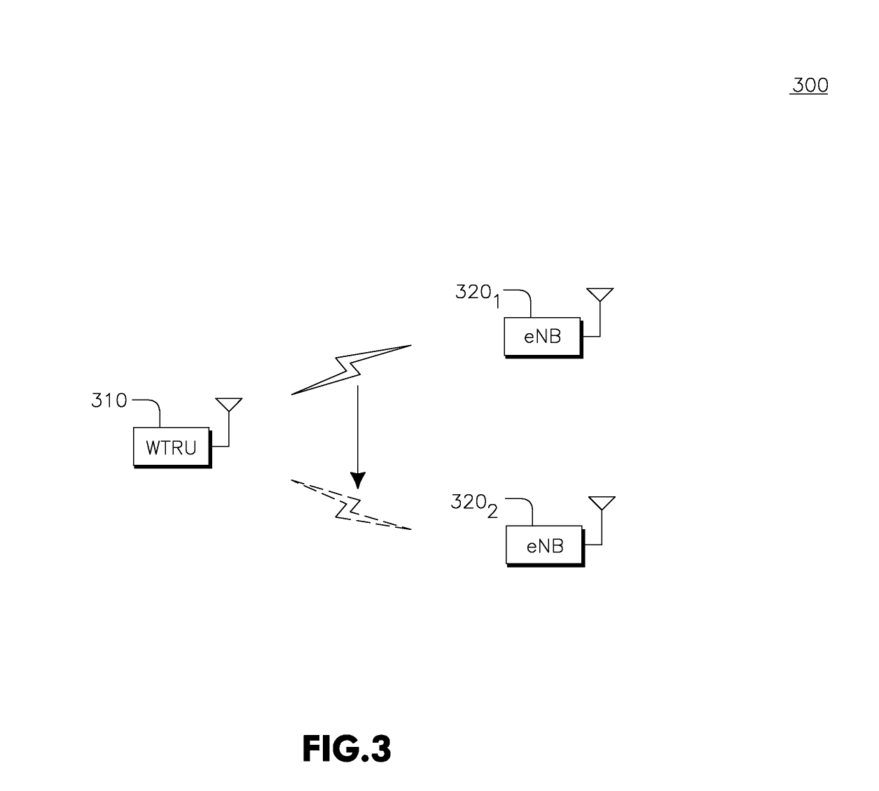

FIG. 3 shows an exemplary wireless communication system 300, including a WTRU 310 and a plurality of eNBs 320 (designated as 320₁ and 320₂), capable of wirelessly communicating with one another. Although the wireless communication devices depicted in the wireless communication system 300 are shown as a single WTRU and two eNBs, it should be understood that any combination of any number of wireless devices may comprise the wireless communication system 300. In the present example, the WTRU 310 is in communication with eNB 320₁, which is the source eNB, and switching to the target eNB 320₂.

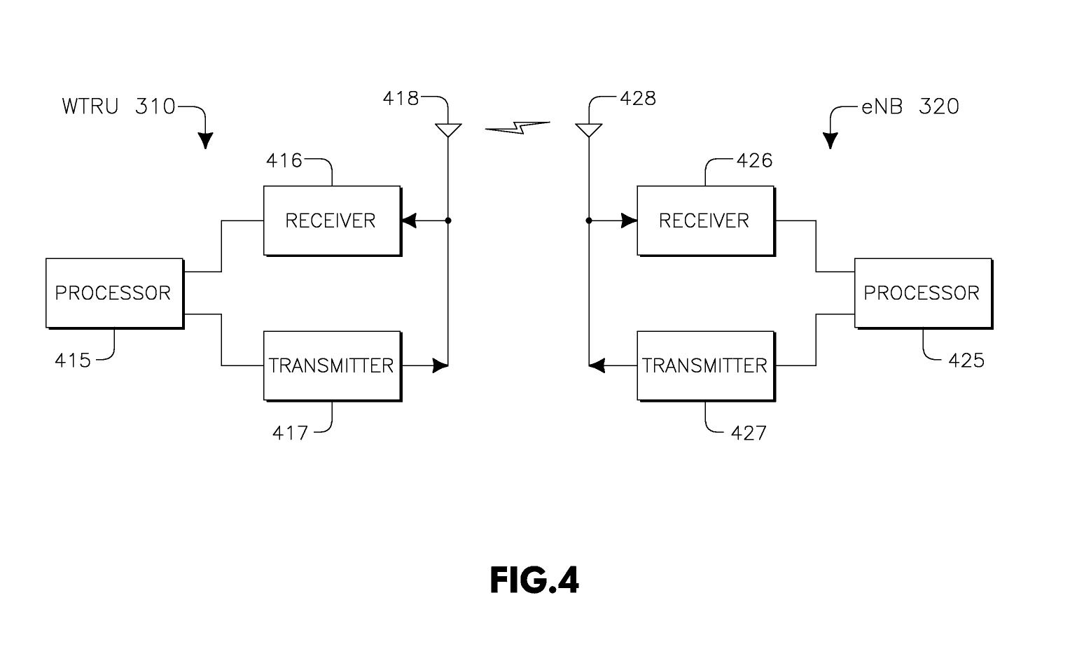

FIG. 4 is a functional block diagram of a WTRU 310 and an eNB 320 of the wireless communication system 300 of FIG. 3. As shown in FIG. 4, the WTRU 310 and the eNB 320 are in wireless communication with one another, and are configured to facilitate lossless handover in the wireless communication system 300 in accordance with the present invention.

In addition to the components that may be found in a typical WTRU, the WTRU 310 includes a processor 415, a receiver 416, a transmitter 417, and an antenna 418. The processor 415 is configured to transmit, receive and process wireless signals related to the facilitation of lossless handover in accordance with the present invention. The receiver 416 and the transmitter 417 are in communication with the processor 415. The antenna 418 is in communication with both the receiver 416 and the transmitter 417 to facilitate the transmission and reception of wireless data.

Similarly, in addition to the components that may be found in a typical eNB, the eNB 320 includes a processor 425, a receiver 426, a transmitter 427, and an antenna 428. The processor 425 is configured to transmit, receive and process wireless signals related to the facilitation of lossless handover in accordance with the present invention. The receiver 426 and the transmitter 427 are in communication with the processor 425. The antenna 428 is in communication with both the receiver 426 and the transmitter 427 to facilitate the transmission and reception of wireless data.

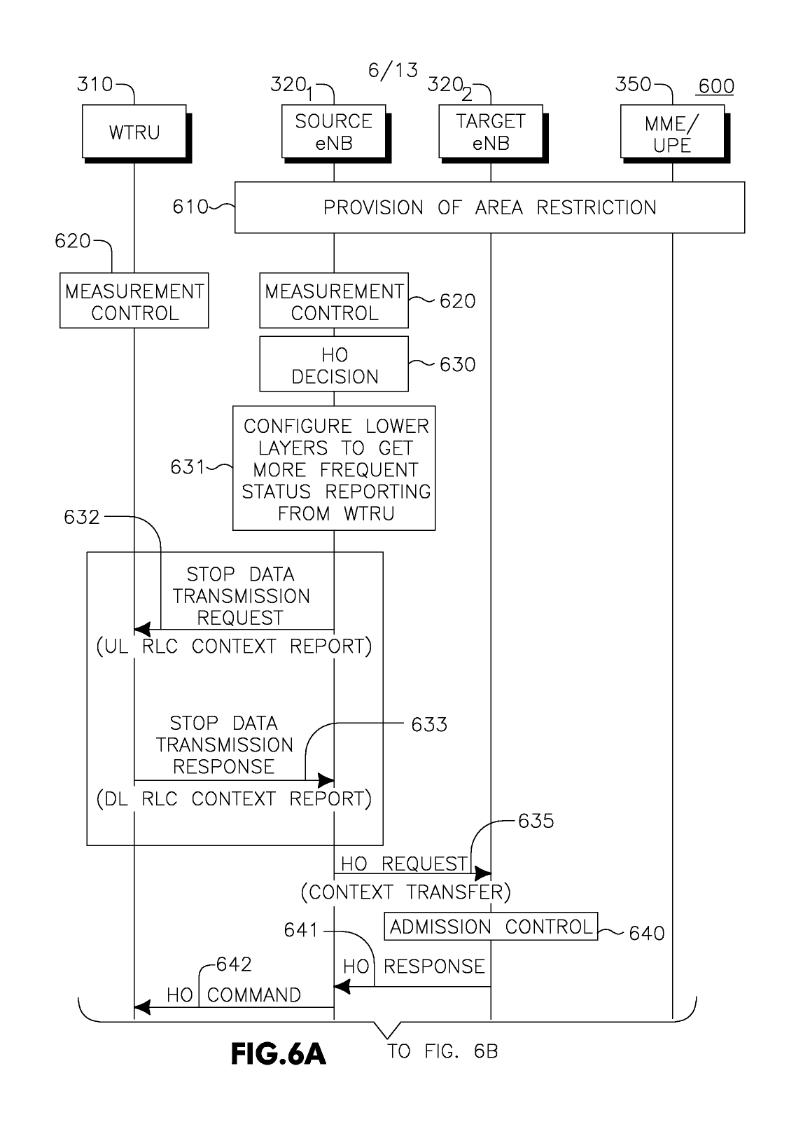

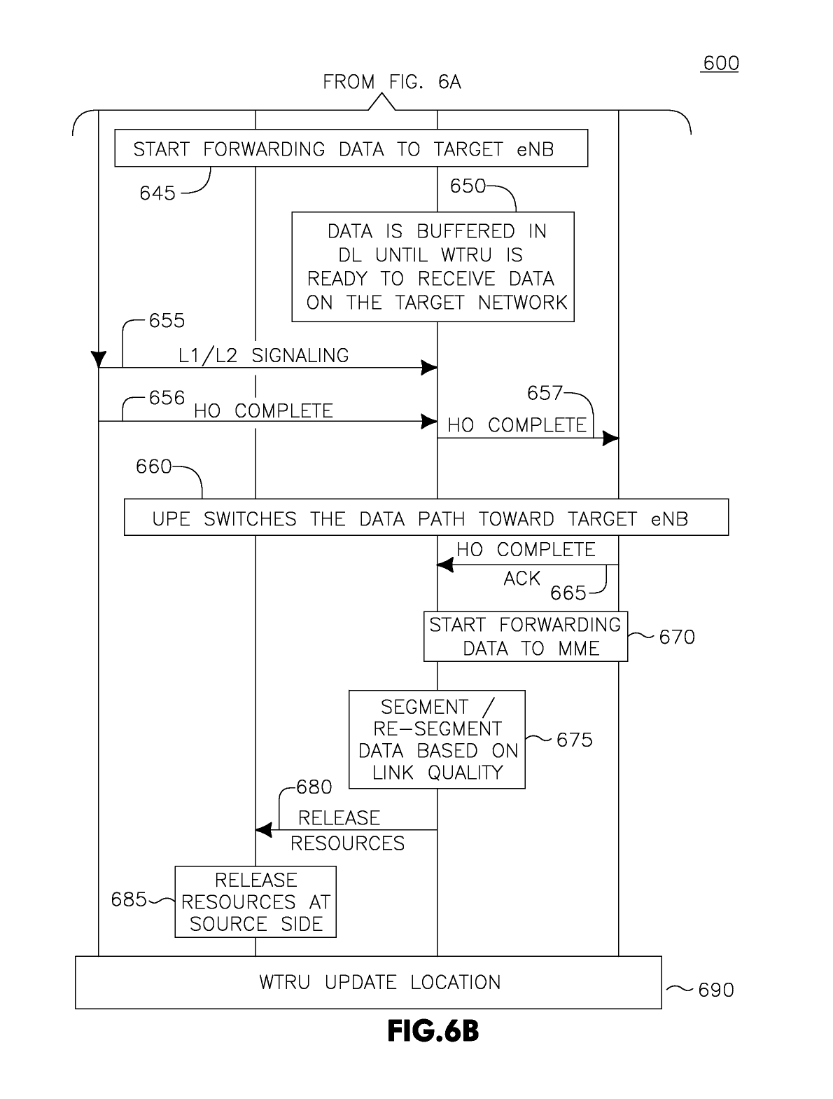

FIG. 6A shows an exemplary SDU format 500 (designated as SDU1) having less often status reporting. The SDU format 500 includes a plurality of PDUs 510 (designated PDU₁, PDU₂, . . . , PDU₈).

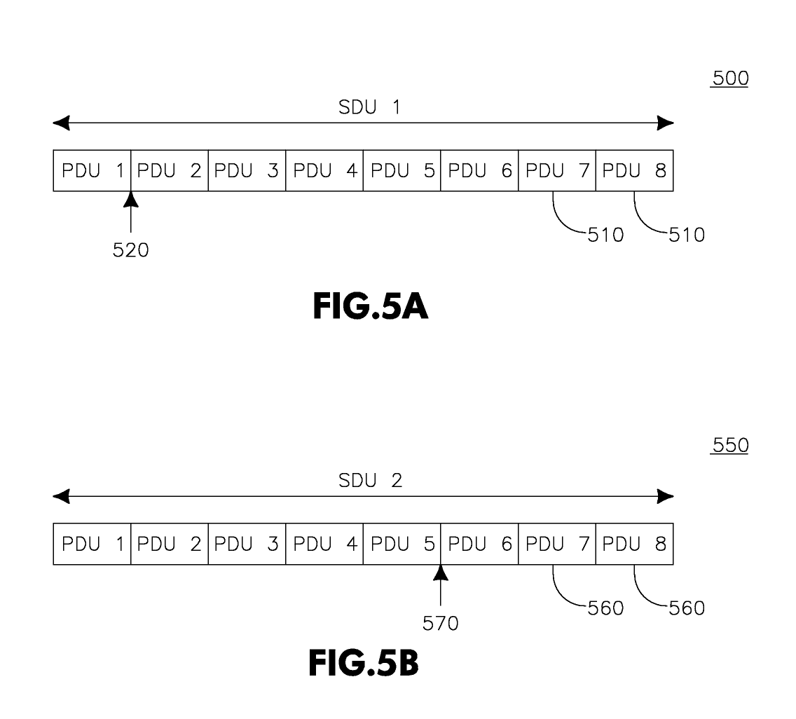

FIG. 5B shows an exemplary SDU format 550 (designated as SDU2) having less often status reporting. The SDU format 550 includes a plurality of PDUs 560 (designated PDU₁, PDU₂, . . . , PDU₈).

FIGS. 6A and 6B show an exemplary signal diagram 600 of a WTRU 310, source eNB 320₁, target eNB 320₂, and MME/UPE 350 performing a method 600 for facilitating lossless handover in the wireless communication system 300 of FIG. 3 in accordance with the present invention. In this example, the WTRU 310 is commanded, preferably by the source eNB 320₁, to stop data transmission once the handover (HO) decision is made. In general, the MME/UPE 350 data path switch from the source eNB 320ᵢ to the target eNB 320₂ is performed at the end of the HO procedure when the HO complete message is sent to the MME/UPE 350.

In step 610, the provision of area restriction is shared between the source eNB 320₁, target eNB 320₂, and MME/UPE 350. In particular, WTRU 310 context information within the source eNB 320₁ contains information regarding roaming restrictions of the WTRU 310. These restrictions may be provided when the WTRU 310 establishes connections or at the last timing advance (TA) update.

The source eNB 320₁ performs measurement control (step 620), where the source eNB 320₁ configures the WTRU 310 measurement procedures according to the area restriction information. The measurement procedures may be utilized by the WTRU 310 to assist in control of the WTRU's connection mobility.

In step 630, the source eNB 320₁ determines to handover the WTRU 310 to a cell controlled by the target eNB 320₂. The source eNB 320₁ may make this determination based upon measurement results from the WTRU and the source eNB 320₁ itself, and may be assisted by additional radio resource management (RRM) information.

The source eNB 320₁ configures lower layers to receive more status reports from the WTRU 310 (step 631). These status reports provide the source eNB 320₁ with more frequent updates as to which packets have been received by the WTRU 310 and which ones have not. Accordingly, if a packet is received out of order, the network will be aware soon, and the context being transferred to the target network will be the most updated context.

The WTRU 310 may be configured through explicit control messaging, such as ARQ messages, or by polling the WTRU often via data or control messages. If the source eNB 320₁ is not able to provide PDU control information to the target eNB 320₂, it can indicate which PDU in the SDU that it received without gaps, such that the target eNB 320₂ will only retransmit PDUs as necessary. For example, referring back to FIGS. 5A, with less often reporting in SDU1, the last update occurs between PDU1 and PDU2 as indicated by the arrow 520. In this case, the target eNB 320₂ will retransmit PDU3 through PDU7. Referring back to FIG. 5B, with more often reporting in SDU2, the last update occurs between PDU5 and PDU6 as indicated by the arrow 570. In this case, the target eNB 320₂ will only retransmit PDU7. In this manner, the number of PDUs needing to be transmitted may be minimized by adding additional reports.

Also, the source eNB 320₁ may transmit a stop data transmission request signal (632) to the WTRU 310. The stop data transmission request signal (632) may also require the WTRU 310 to send data in the uplink (UL), and may contain an uplink (UL) radio link controller (RLC) context report. The WTRU 310 may respond to the stop data transmission request signal by transmitting a stop data transmission response signal (633), which contains a downlink (DL) RLC context report.

The source eNB 320₁ transmits an HO request signal (635) to the target eNB 320₂, which contains context information to prepare for the HO at the target side. The target eNB 320₂ then configures the required resources and performs admission control (640) to increase the likelihood of a successful HO if the resources are able to be granted to the WTRU 310 by the target eNB 320₂.

The target eNB 320₂ transmits an HO response signal (641) to the source eNB 320₁ to indicate the availability of resources in the network. Upon receiving the HO response signal, the source eNB 320₁ transmits an HO command (642) to the WTRU 310 instructing it to perform the HO. During this phase, the source eNB 320₁ begins forwarding data to the target eNB 320₂(645) and keeps a copy of all forwarded packets in a buffer until resources are released on the source network. Additionally, the target eNB 320₂ buffers data in the DL until the WTRU is switched to and ready to receive data on the target network (650).

The source eNB 320₁ may also send an RLC SDU in the UL to the UPE until the handover is completed. Alternatively, it may forward traffic in the UL when it begins forwarding data to the target eNB 320₂.

The WTRU 310 synchronizes with the target eNB 320₂, preferably via layer 2/layer 3 (L2/L3) signaling (655). Once the WTRU 310 successfully accesses and synchronizes with the target cell, the WTRU 310 transmits an HO complete signal (656) to the target eNB 320₂. The target eNB 320₂ forwards the HO complete signal to the MME/UPE 350 (657) to inform it that the WTRU's data path has been switched to the target cell and THL resources in the source cell can be released.

The MME/UPE 350 then switches the data path to the target eNB 320₂ (660), and transmits an HO complete ACK signal to the target eNB 320₂ (665). The target eNB 320₂ begins forwarding data to the MME/UPE 350 (670). The target eNB 320₂ may then segment or resegment data based on the information received from the source network and on the wireless link quality between the target eNB 320₂ and the WTRU 310 (675). The target eNB 320₂ transmits a release resources signal (680) to the source eNB 320₁, and the source eNB 320₂ then releases radio, context, and TNL resources at the source side (685).

The WTRU 310 performs an update of location (690) if the new cell is a member of a new tracking area. The WTRU 310 registers with the MME/UPE 350, which in turn updates the area restriction information on the target side.

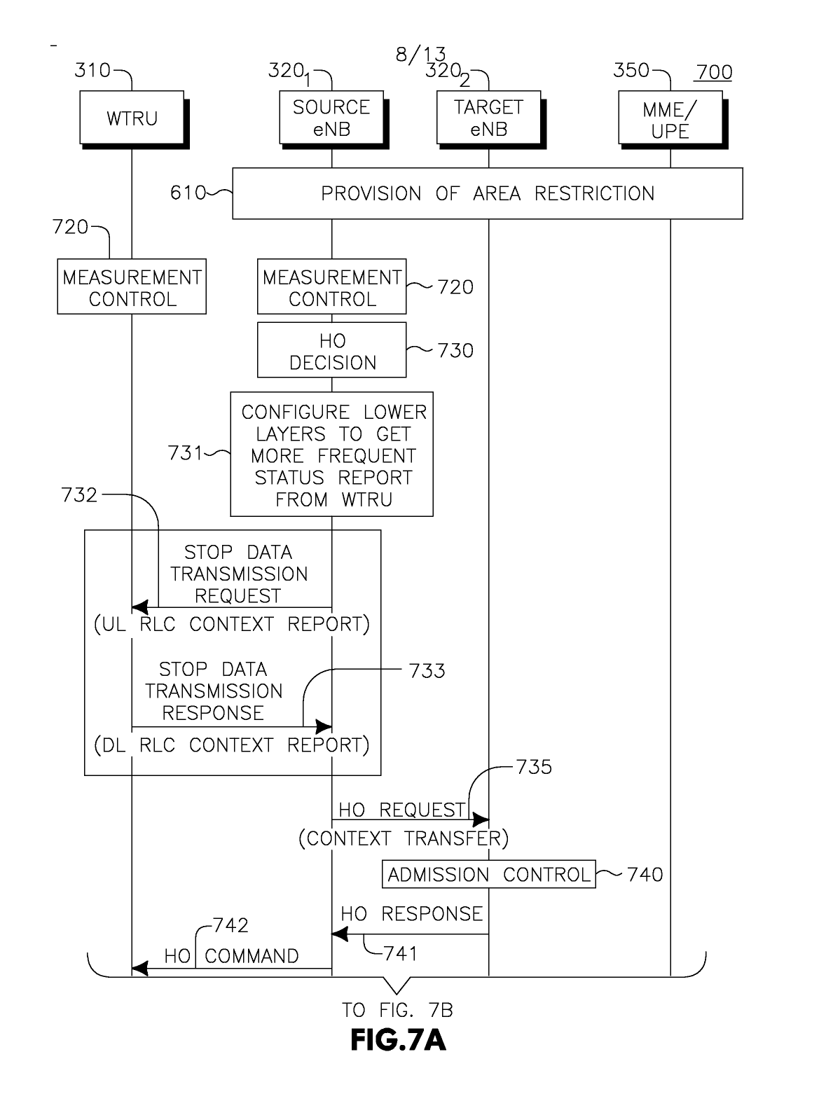

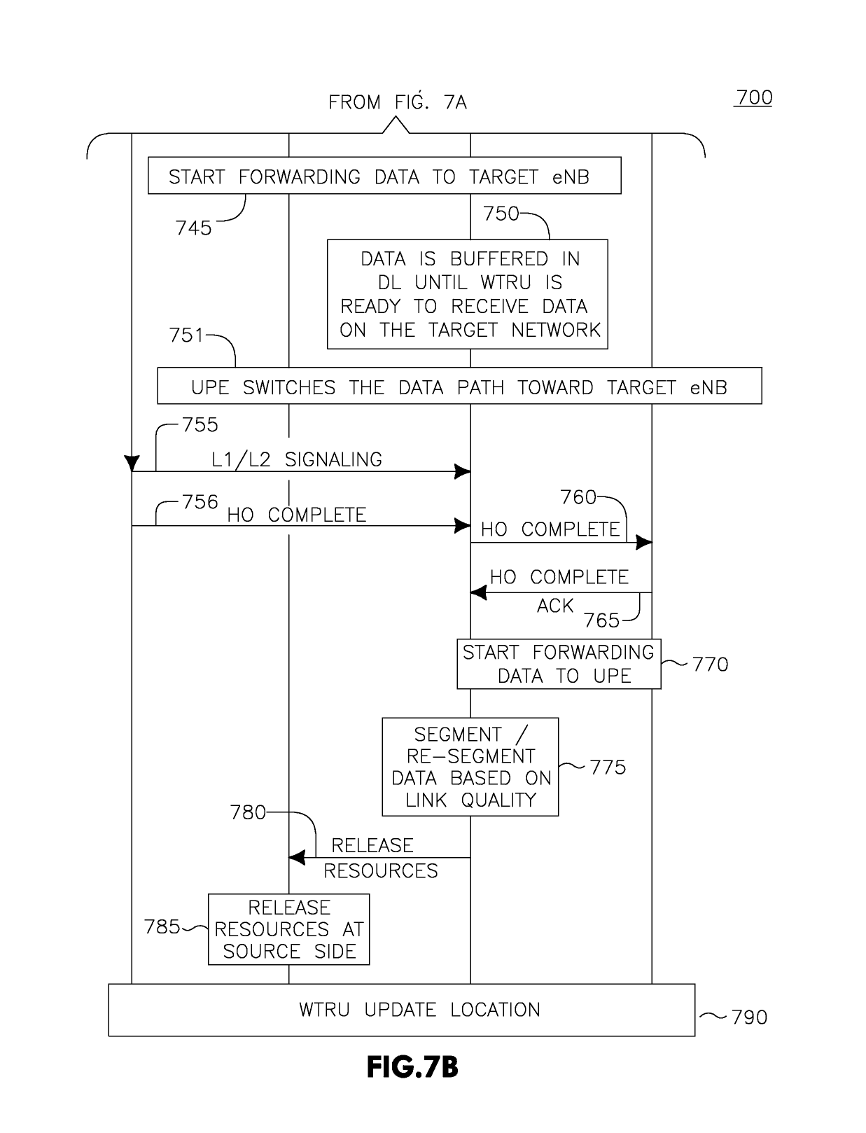

FIGS. 7A and 7B show an exemplary signal diagram 700 of the WTRU 310, source eNB 320₁, target eNB 320₂, and MME/UPE 350 performing another method for facilitating lossless handover in the wireless communication system 300 of FIG. 3 in accordance with the present invention. In this case, the MME/UPE 350 switches the data paths from the source eNB 320₁ to the target eNB 320₂ once the HO command is transmitted to the WTRU 310.

In step 710, the provision of area restriction is shared between the source eNB 320₁, target eNB 320₂, and MME/UPE 350. In particular, WTRU 310 context information within the source eNB 320₁ contains information regarding roaming restrictions of the WTRU 310. Similarly to the method 600, restrictions may be provided when the WTRU 310 establishes connections or at the last timing advance (TA) update.

The source eNB 320ᵢ performs measurement control (step 720), where the source eNB 320₁ configures the WTRU 310 measurement procedures according to the area restriction information. The measurement procedures may be utilized by the WTRU 310 to assist in control of the WTRU's connection mobility.

In step 730, the source eNB 320₁ determines to handover the WTRU 310 to a cell controlled by the target eNB 320₂. The source eNB 320₁ may make this determination based upon measurement results from the WTRU and the source eNB 320₁ itself, and may be assisted by additional radio resource management (RRM) information.

The source eNB 320₁ configures lower layers to receive more status reports from the WTRU 310 (step 731). These status reports provide the source eNB 320₁ with more frequent updates as to which packets have been received by the WTRU 310 and which ones have not. Accordingly, if a packet is received out of order, the network will be aware soon, and the context being transferred to the target network will be the most updated context.

The WTRU 310 may be configured through explicit control messaging, such as ARQ messages, or by polling the WTRU often via data or control messages. If the source eNB 320₁ is not able to provide PDU control information to the target eNB 320₂, it can indicate which PDU in the SDU that it received without gaps, such that the target eNB 320₂ will only retransmit PDUs as necessary. For example, again referring back to FIG. 5A, with less often reporting in SDU1, the last update occurs between PDU1 and PDU2 as indicated by the arrow 520. In this case, the target eNB 320₂ will retransmit PDU3 through PDU7. Referring back to FIG. 5B, with more often reporting in SDU2, the last update occurs between PDU5 and PDU6 as indicated by the arrow 570. In this case, the target eNB 320₂ will only retransmit PDU7.

Also, the source eNB 320₁ may transmit a stop data transmission request signal (732) to the WTRU 310. The stop data transmission request signal (732) may also require the WTRU 310 to send data in the uplink (UL), and may contain an uplink (UL) radio link controller (RLC) context report. The WTRU 310 may respond to the stop data transmission request signal by transmitting a stop data transmission response signal (733), which contains a downlink (DL) RLC context report.

The source eNB 320₁ transmits an HO request signal (735) to the target eNB 320₂, which contains context information to prepare for the HO at the target side. The target eNB 320₂ then configures the required resources and performs admission control (740) to increase the likelihood of a successful HO if the resources are able to be granted to the WTRU 310 by the target eNB 320₂.

The target eNB 320₂ transmits an HO response signal (741) to the source eNB 320₁ to indicate the availability of resources in the network. Upon receiving the HO response signal, the source eNB 320₁ transmits an HO command (742) to the WTRU 310 instructing it to perform the HO. During this phase, the source eNB 320₁ begins forwarding data to the target eNB 320₂ (745) and keeps a copy of all forwarded packets in a buffer until resources are released on the source network. Additionally, the target eNB 320₂ buffers data in the DL until the WTRU is switched to and ready to receive data on the target network (750).

At this point, the MME/UPE 350 then switches the data path to the target eNB 320₂ (751). The WTRU 310 synchronizes with the target eNB 320₂, preferably via layer 2/layer 3 (L2/L3) signaling (755). Once the WTRU 310 successfully accesses and synchronizes with the target cell, the WTRU 310 transmits an HO complete signal (756) to the target eNB 320₂. The target eNB 320₂ forwards the HO complete signal to the MME/UPE 350 (760) to inform it that the WTRU's data path has been switched to the target cell and TNL resources in the source cell can be released.

The MME/UPE 350 then transmits an HO complete ACK signal to the target eNB 320₂ (765). The target eNB 320₂ begins forwarding data to the MME/UPE 350 (770). The target eNB 320₂ may then segment or resegment data based on the information received from the source network and on the wireless link quality between the target eNB 320₂ and the WTRU 310 (775). The target eNB 320₂ transmits a release resources signal (780) to the source eNB 320₁, and the source eNB 320₂ then releases radio, context, and TNL resources at the source side (785).

The WTRU 310 performs an update of location (790) if the new cell is a member of a new tracking area. The WTRU 310 registers with the MME/UPE 350, which in turn updates the area restriction information on the target side.

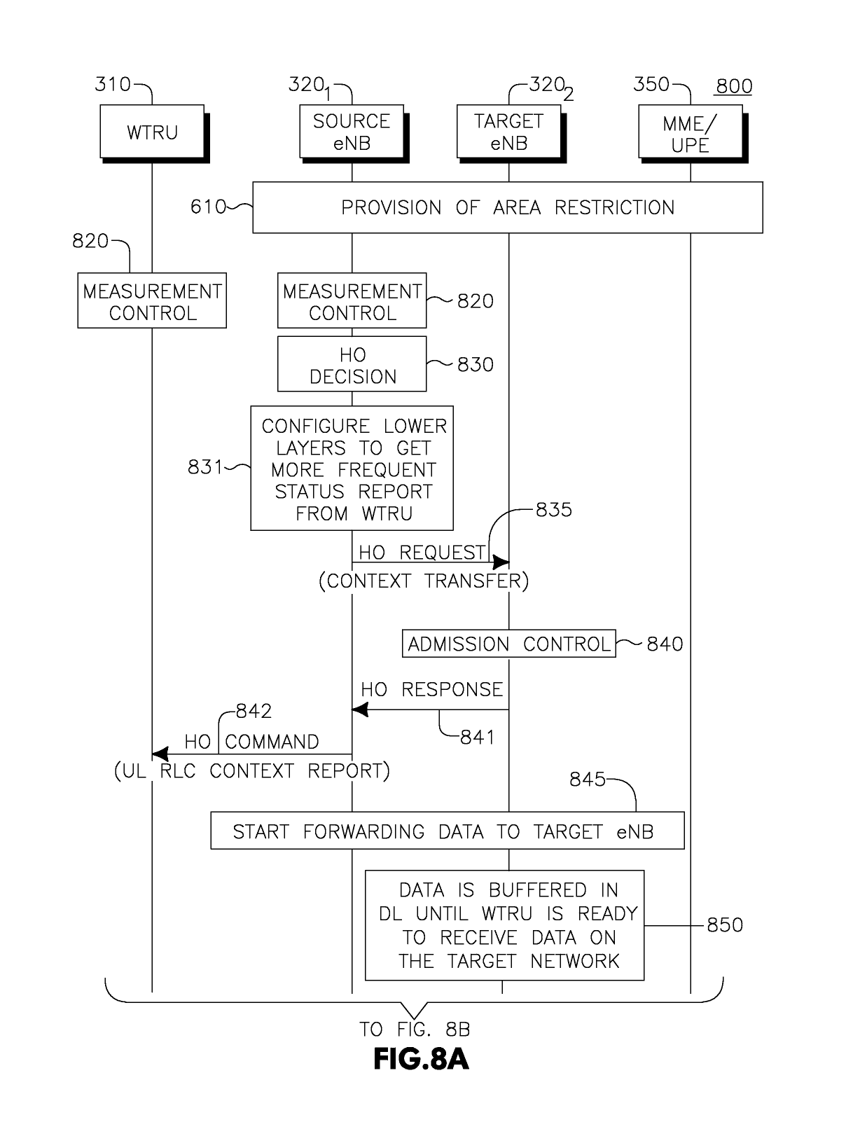

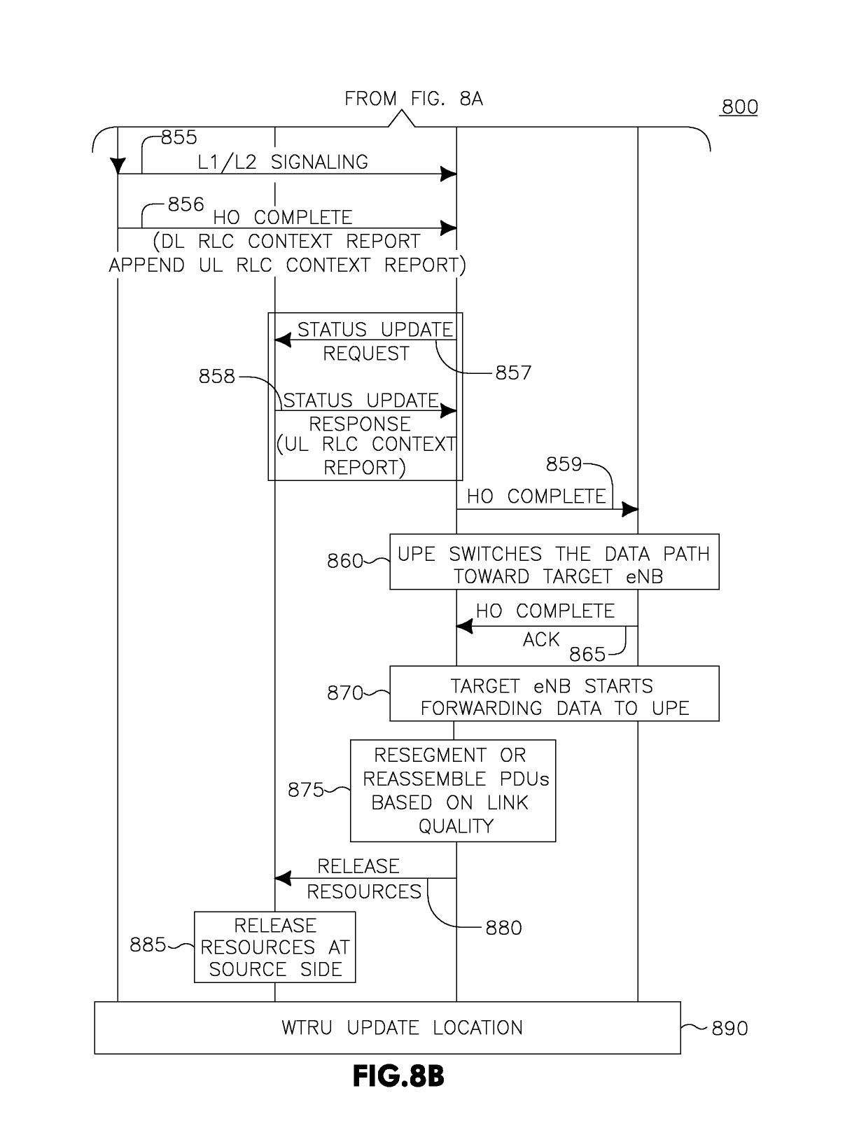

FIGS. 8A and 8B show an exemplary signal diagram 800 of the WTRU 310, source eNB 320₁, target eNB 320₂, and MME/UPE 350 performing another method for facilitating lossless handover in the wireless communication system 300 of FIG. 3 in accordance with the present invention. In this scenario, the network stops transmission once the HO decision is made, but the WTRU 310 continues to transmit data in the UL.

In step 810, the provision of area restriction is shared between the source eNB 320₁, target eNB 320₂, and MME/UPE 350. In particular, WTRU 310 context information within the source eNB 320₁ contains information regarding roaming restrictions of the WTRU 310. Similarly to the method 600, restrictions may be provided when the WTRU 310 establishes connections or at the last timing advance (TA) update.

The source eNB 320₁ performs measurement control (step 820), where the source eNB 320₁ configures the WTRU 310 measurement procedures according to the area restriction information. The measurement procedures may be utilized by the WTRU 310 to assist in control of the WTRU's connection mobility.

In step 830, the source eNB 320₁ determines to handover the WTRU 310 to a cell controlled by the target eNB 320₂. The source eNB 320₁ may make this determination based upon measurement results from the WTRU and the source eNB 320₁ itself, and may be assisted by additional radio resource management (RRM) information.

The source eNB 320₁ configures lower layers to receive more status reports from the WTRU 310 (step 831). These status reports provide the source eNB 320₁ with more frequent updates as to which packets have been received by the WTRU 310 and which ones have not. Accordingly, if a packet is received out of order, the network will be aware soon, and the context being transferred to the target network will be the most updated context.

The source eNB 320₁ transmits an HO request signal (835) to the target eNB 320₂, which contains context information to prepare for the HO at the target side. The target eNB 320₂ then configures the required resources and performs admission control (840) to increase the likelihood of a successful HO if the resources are able to be granted to the WTRU 310 by the target eNB 320₂.

The target eNB 320₂ transmits an HO response signal (841) to the source eNB 320₁ to indicate the availability of resources in the network. Upon receiving the HO response signal, the source eNB 320₁ transmits an HO command (842) to the WTRU 310 instructing it to perform the HO. The HO command (842) also includes a UL RLC context report. During this phase, the source eNB 320₁ begins forwarding data to the target eNB 320₂ (845) and keeps a copy of all forwarded packets in a buffer until resources are released on the source network. The source eNB 320₁ may forward traffic to the MME/UPE 350 at this point. Additionally, the target eNB 320₂ buffers data in the DL until the WTRU is switched to and ready to receive data on the target network (850). Alternatively, the source eNB 320₁ may transmit an RLC SDU in the UL to the MME/UPE 350 until the HO is completed.

The WTRU 310 synchronizes with the target eNB 320₂, preferably via layer 2/layer 3 (L2/L3) signaling (855). Once the WTRU 310 successfully accesses and synchronizes with the target cell, the WTRU 310 transmits an HO complete signal (856) to the target eNB 320₂, which contains a DL RLC context report and may also contain the UL RLC context report received from the source eNB 320₁.

If status updating was not appended in the HO complete message, the target eNB 320₂ transmits a status update request signal (857) to the source eNB 320ᵢ requesting the UL RLC context report. The source eNB 320₁ responds by sending the UL RLC context report in a status update response signal (858) to the target 320₂.

The target eNB 320₂ forwards the HO complete signal to the MME/UPE 350 (859) to inform it that the WTRU's data path has been switched to the target cell and TNL resources in the source cell can be released. At this point, the MME/UPE 350 then switches the data path to the target eNB 320₂ (860).

The MME/UPE 350 then transmits an HO complete ACK signal to the target eNB 320₂ (865). The target eNB 320₂ begins forwarding data to the MME/UPE 350 (870). The target eNB 320₂ may then segment or resegment data based on the information received from the source network and on the wireless link quality between the target eNB 320₂ and the WTRU 310 (875). The target eNB 320₂ transmits a release resources signal (880) to the source eNB 320₁, and the source eNB 320₂ then releases radio, context, and TNL resources at the source side (885).

The WTRU 310 performs an update of location (890) if the new cell is a member of a new tracking area. The WTRU 310 registers with the MME/UPE 350, which in turn updates the area restriction information on the target side.

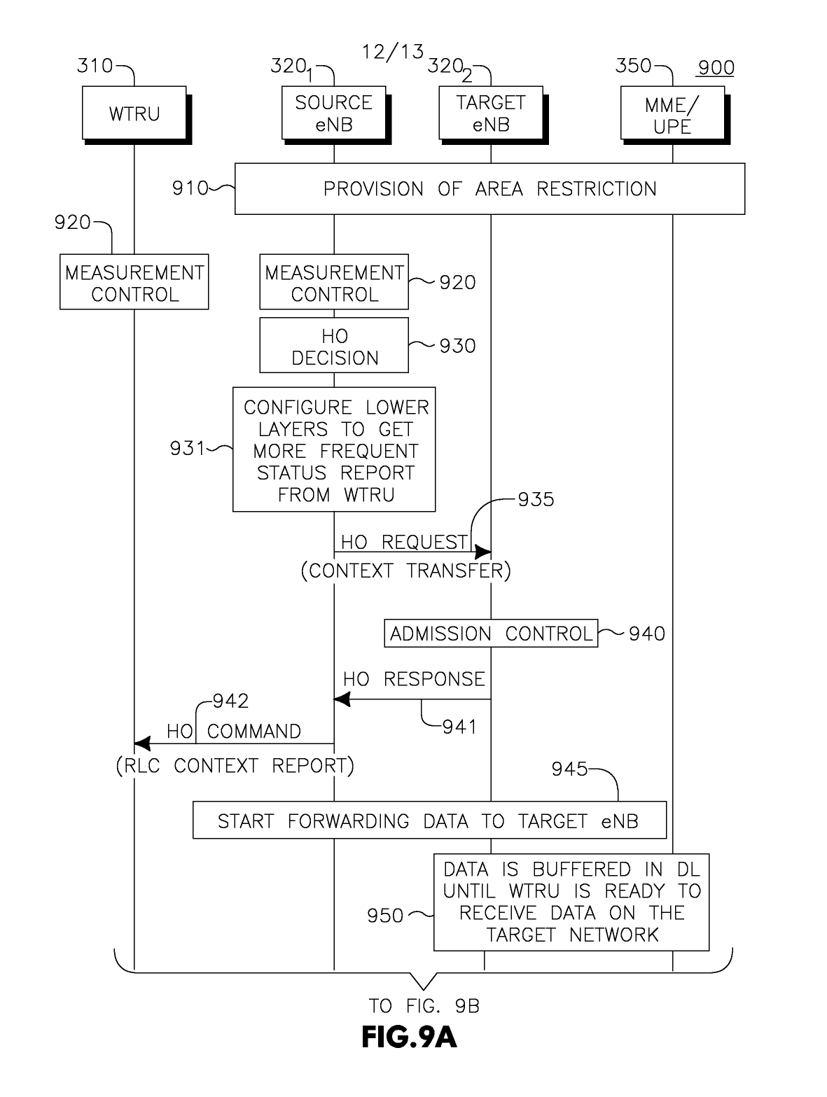

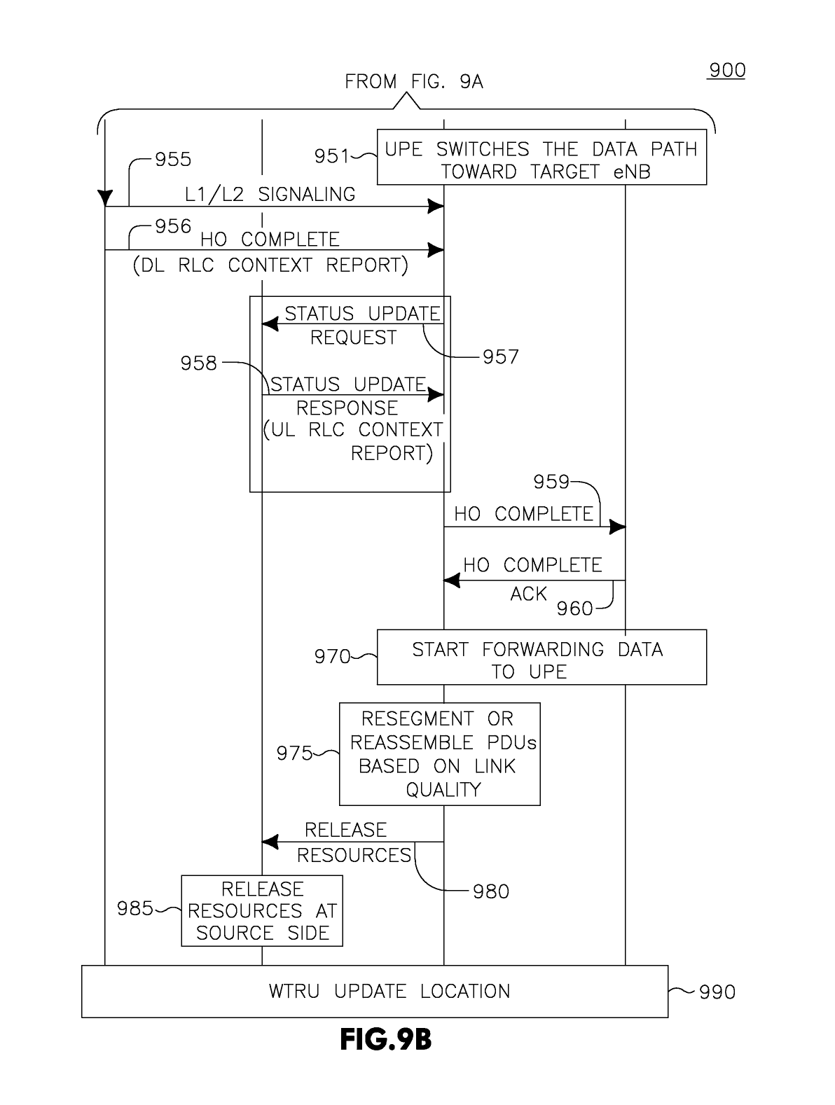

FIGS. 9A and 9B show an exemplary signal diagram 900 of the WTRU 310, source eNB 320₁, target eNB 320₂, and MME/UPE 350 performing another method for facilitating lossless handover in the wireless communication system 300 of FIG. 3 in accordance with the present invention. In this scenario, the MME/UPE 350 switches the data path earlier from the source eNB 320₁ to the target eNB 320₂ once the HO command is transmitted to the WTRU 310.

In step 910, the provision of area restriction is shared between the source eNB 320₁, target eNB 320₂, and MME/UPE 350. In particular, WTRU 310 context information within the source eNB 320₁ contains information regarding roaming restrictions of the WTRU 310. Similarly to the method 600, restrictions may be provided when the WTRU 310 establishes connections or at the last timing advance (TA) update.

The source eNB 320₁ performs measurement control (step 920), where the source eNB 320₁ configures the WTRU 310 measurement procedures according to the area restriction information. The measurement procedures may be utilized by the WTRU 310 to assist in control of the WTRU's connection mobility.

In step 930, the source eNB 320₁ determines to handover the WTRU 310 to a cell controlled by the target eNB 320₂. The source eNB 320₁ may make this determination based upon measurement results from the WTRU and the source eNB 320₁ itself, and may be assisted by additional radio resource management (RRM) information.

The source eNB 320₁ configures lower layers to receive more status reports from the WTRU 310 (step 931). These status reports provide the source eNB 320₁ with more frequent updates as to which packets have been received by the WTRU 310 and which ones have not. Accordingly, if a packet is received out of order, the network will be aware soon, and the context being transferred to the target network will be the most updated context.

The source eNB 320₁ transmits an HO request signal (935) to the target eNB 320₂, which contains context information to prepare for the HO at the target side. The target eNB 320₂ then configures the required resources and performs admission control (940) to increase the likelihood of a successful HO if the resources are able to be granted to the WTRU 310 by the target eNB 320₂.

The target eNB 320₂ transmits an HO response signal (941) to the source eNB 320₁ to indicate the availability of resources in the network. Upon receiving the HO response signal, the source eNB 320₁ transmits an HO command (942) to the WTRU 310 instructing it to perform the HO. The HO command (942) also includes a UL RLC context report. During this phase, the source eNB 320₁ begins forwarding data to the target eNB 320₂ (945) and keeps a copy of all forwarded packets in a buffer until resources are released on the source network. The source eNB 320₁ may forward traffic to the MME/UPE 350 at this point. Additionally, the target eNB 320₂ buffers data in the DL until the WTRU is switched to and ready to receive data on the target network (950). Alternatively, the source eNB 320₁ may transmit an RLC SDU in the UL to the MME/UPE 350 until the HO is completed.

The MME/UPE 350 then switches the data path to the target eNB 320₂ (951). The WTRU 310 synchronizes with the target eNB 320₂, preferably via layer 2/layer 3 (L2/L3) signaling (955). Once the WTRU 310 successfully accesses and synchronizes with the target cell, the WTRU 310 transmits an HO complete signal (956) to the target eNB 320₂, which contains a DL RLC context report and may also contain the UL RLC context report received from the source eNB 320₁.

If status updating was not appended in the HO complete message, the target eNB 320₂ transmits a status update request signal (957) to the source eNB 320₁ requesting the UL RLC context report. The source eNB 320ᵢ responds by sending the UL RLC context report in a status update response signal (958) to the target 320₂.

The target eNB 320₂ forwards the HO complete signal to the MME/UPE 350 (959) to inform it that the WTRU's data path has been switched to the target cell and TNL resources in the source cell can be released.

The MME/UPE 350 then transmits an HO complete ACK signal to the target eNB 320₂ (960). The target eNB 320₂ begins forwarding data to the MME/UPE 350 (970). The target eNB 320₂ may then segment or resegment data based on the information received from the source network and on the wireless link quality between the target eNB 320₂ and the WTRU 310 (975). The target eNB 320₂ transmits a release resources signal (980) to the source eNB 320₁, and the source eNB 320₂ then releases radio, context, and TNL resources at the source side (985).

The WTRU 310 performs an update of location (990) if the new cell is a member of a new tracking area. The WTRU 310 registers with the MME/UPE 350, which in turn updates the area restriction information on the target side.

Alternatively to the methods 600, 700, 800, and 900 described above, another embodiment is to synchronize the HO procedure and consequently, the source eNB 320₁ forwards the RLC context and traffic to the target eNB 320₂ at the same time the WTRU 310 switches to the target network. The data path switch to the aGW may also occur at this time.

The context information transferred from the source eNB 320₁ to the target eNB 320₂ in the methods described above includes a variety of data. For example, the information may include security parameters, MS network capability, MS class capability, DRX parameters, RAB configuration parameters, and session management parameters. Additionally, each parameter may include additional information.

For example, security parameters may include security keys, authentication vectors, ciphering keys for RRC and MAC signaling, and integrity protection keys for RRC signaling and possibly MAC signaling.

Session management parameters may include session/transaction identifier and a quality of service (QoS) Profile with QoS parameters such as subscribed, requested, negotiated, granted, and the like, AGW (UPE and MME) addresses, PDCP/RLC SDU information, RRC configuration and RLC configuration. Additionally, the QoS parameters may include traffic class, maximum SDU size, mean throughput, minimum and maximum bit rate in uplink and downlink, delay, jitter, guaranteed bit rate in downlink and uplink, and the like, and service type, such as voice over internet protocol (VoIP), interactive, and the like. The requirement for this service type may be hard coded on network and WTRU side. The PDCP/RLC SDU information may include the next sequence number (SN) that is sent from a target eNB 320₂ in DL or the next SN received from a WTRU in UL.

As described in the various methods 600, 700, 800, and 900 above, in order to facilitate a lossless handover, the forwarding of data and the transfer of protocol context information, (e.g., layer 2 context), is necessary from the source eNB 320₁ to the target eNB 320₂. Additionally, some or all of the RLC context information, such as state variables, will need to be transferred.

The following description relates to some of the important RLC context information that will need to be transferred if lossless handover is to be achieved. A list of information/context is provided that should be passed between a source eNB 320₁ and target eNB 320₂ for an LTE system. Such information/context can also include RLC configuration parameters similar to the 3GPP R6 RLC protocol configuration parameters.

The source eNB 320₁ updates the RLC transmitter (Tx) based on the status report from the WTRU 310 and the local ACK/NACK indication from the HARQ process. The source eNB 320₁ updates the RLC receiver (Rx) based on the packet it has received from the WTRU 310. The RLC Rx can update its context based on the status report (or polling request) from the WTRU 310 regarding the transmitted SDU (or PDU) from the WTRU 310. The status messages (PDUs) that are sent by the RLC Rx to the RLC Tx may contain important context updates which are used to update the RLC Tx context. Similarly, a status report from RLC Tx can inform the RLC Rx about the SDU packet (and/or PDU packet) transferred so far.

During handover, the frequency of status updates (or context updates in general) is preferably increased, in order to ensure that lossless handover is achieved smoothly. To achieve this, some of the RLC parameters are reconfigured, such as those used to poll for status. Also, the necessary signals are sent to change some of the RLC timers, such as the RLC Prohibit status timer, which can limit the number of status PDUs sent. The reconfiguration can happen via explicit signaling from NodeB to WTRU. However, it may take longer, resulting in a waste of radio resources.

Accordingly, it may be optimal to allow the WTRU 310 to change the polling and timer values automatically after a measurement report is triggered due to a handover condition. Alternatively, another process may be to send a status report between the WTRU 310 and source eNB 320₁ during the HO command of methods 600, 700, 800, and 900. For example, an HO command from source eNB 320₁ to WTRU 310 may contain a status report for the uplink direction from the RLC Rx and a status report on downlink packets from the RLC Tx. Additionally, the HO Command may trigger the WTRU 310 to send a status report from the RLC Tx (and RLC Rx) to the target eNB 320₂. This command can be sent multiplexed with the HO response command from WTRU 310 to target eNB 320₂.

Since the status messages coming from the RLC Rx to the RLC Tx apply and describe context updates that are applicable on a PDU level, a translation or mapping mechanism, such as a function or entity, that can map the PDU-level context information onto SDU-level context information may be needed. For example, in the segmentation case, where an SDU may consist of several PDUs (segments), the mapping of a PDU-level acknowledgement status onto an SDU-level acknowledgement status can be achieved by considering an SDU successfully acknowledged if all its PDUs are successfully acknowledged. In the concatenation case, where multiple SDUs may form a single PDU, the mapping of PDU-level acknowledgement status onto an SDU-level acknowledgement status can be achieved by considering an SDU successfully acknowledged if the PDU containing the SDU is successfully acknowledged.

In general, context transfer can occur in multiple occasions or phases during handover, whereby during the initial context transfer, the most recent RLC Context is transferred between the source eNB 320₁ and the target eNB 320₂. However, subsequent context transfers can take place when the RLC Context is updated, for example, if the source eNB 320₁ receives new status messages.

Furthermore, during HO, the RLC Tx in the source eNB 320₁, upon receiving an RLC status from the RLC Rx at the WTRU 310, or a local ACK or NACK from the HARQ Tx, performs the following operations: translating or mapping the acknowledgement status into the level necessary to achieve efficient usage of the wireless medium, (e.g., mapping PDU acknowledgment status into SDU and/or ‘octet range’ acknowledgment status); creating/building a context transfer message/signal; and forwarding the context transfer message/signal to the target eNB 320₂.

Also, during HO, the RLC Rx in the source eNB 320₁, upon receiving an RLC PDU, performs the following operations: translating or mapping the reception status into the level necessary to achieve efficient usage of the wireless medium, (e.g., mapping PDU reception status into SDU and/or ‘octet range’ reception status); creating/building a context transfer message/signal; and forwarding the context transfer message/signal to the target eNB 320₂.

The RLC context can generally be classified under the following categories: data flow control, (e.g., ARQ), such as acknowledgements and next packets to transmit; timers that are used to decide when to transmit, retransmit or discard certain packets and the like; and configurations, such as maximum number of transmissions, and the like.

The following describes detailed information related to mainly the data flow control, such as the ARQ category. For the RLC timers and RLC configurations, the value of some timers is sent as part of the context transfer messages. The remainder of the timers should be indicated to be reset at the target eNB 320₂. For example, timers associated with polling status and reporting status should be reset at the target eNB 320₂. Timers associated with time to live for an SDU packet should be sent to the target eNB 320₂. Timers associated with SDU reordering timeout may be reset based on the application type. For a strict latency application, it may be preferable to send the timer as part of the context transfer. For other traffic types, the timer should be indicated to be reset.

For the RLC configurations, some or all of the RLC configuration parameters may be transferred as part of the context transfer messages. Alternatively, they may be reset at the target eNB 320₂.

For example, configuration parameters such as maximum transmission window size, maximum reception window size, maximum number of transmissions for data packets, maximum number of transmissions for control packets or any other packets, the RLC mode, (e.g., acknowledged, unacknowledged or transparent), and the like, could be transferred as part of the context. Alternatively, if such configuration parameters are not transferred, then the target eNB 320₂ can revert to using default parameters that are stored in or accessible to the target eNB 320₂. As an alternative, the target eNB 320₂ may receive a pointer, (e.g., Configuration or Profile Identifier) that points to a configuration profile that the target eNB 320₂ can use to look up the detailed configuration parameters from a database that resides in the target eNB 320₂ or elsewhere, such as in the access gateway, in the node containing the MME/UPE, or in any other node.

Since it is possible to have multiple RLC instances for a given user in 3GPP LTE running in the WTRU or in the eNB, these multiple RLC instances can be used to provide different services, such as VoIP and TCP traffic. Accordingly, during context transfer, the context of each RLC instance is transferred from the source eNB 320₁ to the target eNB 320₂, either in sequence or in parallel. The target eNB 320₂ may decide to accept or reject some of those RLC instances, (e.g., if the target eNB 320₂ has resources to admit some but not all services), based on the target eNB 320₂ admission control procedures.

Alternatively, the context of several RLC instances may be aggregated and sent to the target eNB 320₂, instead of being sent individually. This method may be more efficient and potentially faster, which will result in faster HO. For example, context transfer messages that are exchanged between eNB's, or between eNB and WTRU, may contain fields or sections that identify the various RLC instances, and that describe the context information of each RLC instance.

Regarding RLC SDU data forwarding, the data forwarding between eNBs is done at the SDU-level, where the source eNB 320₁ forwards only the RLC SDUs as data, and does not forward RLC PDUs. Therefore, for UL traffic, where the RLC Rx side resides in the eNB, for each logical Channel or MAC flow, the source eNB 320₁ forwards to either the target eNB 320₂ or the node containing the MME/UPE all the SDUs that have been received from the WTRU 310.

During a handover scenario, for DL traffic, where the RLC Tx side resides in the eNB, for each logical channel or MAC flow the source eNB 320₁ forwards to the target eNB 320₂ all the SDUs that have not been transmitted to the WTRU 310 and all the SDUs that have not been acknowledged by the WTRU 310.

To facilitate the context transfer in the RLC SDU data forwarding, SDU-level context information is synthesized and transferred, whereby the context is described at the SDU-level. Additionally, the synthesis and transfer of PDU-level context information, in addition to, or in lieu of, the SDU-level context information, whereby the context is described at the PDU-level and/or at the SDU-level is facilitated. The synthesis and transfer of Octet-level context information and/or PDU-level context information, in addition to, or in lieu of, the SDU-level context information, whereby the context is described at the Octet-level and/or at the PDU-level and/or at the SDU-level is facilitated.

By combining data forwarding at the SDU-level with context transferring at the finer levels of Octet and/or PDU-levels in addition to the SDU-level, high efficiency lossless handover may be facilitated through avoiding unnecessary retransmission of previously transmitted data.

In another alternative, the source eNB 320₁ transfers SDU-level context information to the target eNB 320₂. This may require the translation of PDU-level context information into SDU-level context information as described above.

For the DL traffic case, when the RLC Tx side resides in the NB, the context information should include one or more of the following: the SN of the next SDU to be transmitted for the first time, the SN following the SN of the last in-sequence acknowledged SDU, and per-SDU acknowledgement status for SDUs with sequence numbers between those. The context information can be transferred multiple times, initially and anytime the context information is updated when the source eNB 320₁ receives new status messages, or when it receives Local ACK/NACK messages from HARQ, for example.

The RLC Tx at the target eNB 320₂ may use of some or all of the above RLC Tx context information to efficiently transmit new data, and/or efficiently retransmit data. For example, the RLC Tx may use the SN of the next SDU to be transmitted for the first time in order to continue transmission from the point where the source eNB 320₁ has stopped. Also, the RLC Tx at the target eNB 320₂ may use of the per-SDU acknowledgement status to identify the SDUs it needs to transmit or retransmit, instead of inefficiently and unnecessarily retransmitting some SDUs that have been previously acknowledged.

For the UL traffic case, when the RLC Rx side resides in the NB, the context information may include one or more of the following: the SN following that of the last in-sequence SDU received, the SN following the highest SN of any received SDU, and the per-SDU reception status for each SDU with an SN between those (i.e. status of whether an SDU is correctly received or not). The context information can be transferred multiple times, initially and anytime the context information is updated when the source eNB 320₁ receives RLC PDUs, for example.

The RLC Rx at the target eNB 320₂ may use of some or all of the above RLC Rx context information to create status or any other messages that will be sent to the WTRU 310 to update the WTRU's RLC context. Additionally, the WTRU 310 may utilize such messages to update any part of its RLC context, for example, to update the RLC Tx context in order to efficiently use the wireless medium by avoiding unnecessary retransmitting packets, (e.g., SDUs).

Any of the RLC Tx, RLC Rx, RLC timers or RLC configuration parameters context information may also be transferred.

In one example, SDU-level RLC Context and PDU-level RLC Context and (possibly with) Octet-level RLC Context is transferred. In this example, the source eNB 320₁ transfers SDU-level context information and the PDU-level context information to the target eNB 320₂, possibly together with some octet-level Context information. For the DL traffic case, when the RLC Tx side resides in the NB, the context information may include one or more of the following:
a) The “Sequence Number” of the next SDU to be transmitted for the first time, and/or the “Sequence Number” of the SDU that is currently undergoing transmission for the first time.
b) For each SDU which is not completely transmitted over the air, a PDU “identifier”, (e.g., “Sequence Number” or “Segment Number”), of the next PDU to be transmitted for the first time.
c) For each SDU which is not completely transmitted over the air, the Octet “identifier”, (e.g., “Octet/Byte Number”), of the next data octet to be transmitted for the first time, (e.g., a pointer to an octet in the SDU being currently transmitted, or in the next SDU to be transmitted for the first time).
d) The “Sequence Number” following the “Sequence Number” of the last in-sequence acknowledged SDU.
e) For each SDU which is not completely transmitted over the air, the PDU “identifier” (e.g., “Sequence Number” or “segment number”), following the “identifier” of the last in-sequence acknowledged PDU.
f) For each SDU which is not completely transmitted over the air, the Octet “identifier” e.g., “Octet/Byte Number” following the “identifier” of the last in-sequence acknowledged octet. (e.g., a pointer to an octet in the last in-sequence acknowledged SDU).
g) Per-SDU acknowledgement status for SDUs with sequence numbers between those in (a) and (d).
h) For each SDU which is not completely transmitted over the air, Per-PDU acknowledgement status for each PDU containing data from SDUs with sequence number between those in (a) and (d).
i) For each SDU which is not completely transmitted over the air, Segmentation Information—Per-PDU segmentation detailed information, (e.g., describing the size or the starting octet of each PDU/segment) for each PDU containing data from SDUs with sequence number between those in points (a) and (d) that has been transmitted by the RLC Tx. For example, the message can contain the size of the first PDU of an SDU, the size of the second PDU of an SDU, or the like. Alternatively, the message can contain the SDU octet number of the first PDU of an SDU, the SDU octet number of the second PDU of an SDU, or the like. If such segmentation information is not provided, the mechanism will still work but less efficiently, since already received and acknowledged portions of the SDU may need to be retransmitted by the target eNB 320₂ anytime it receives a negative acknowledgement for one of the SDU's constituent PDUs.

The above context information can be transferred multiple times, initially and anytime the context information is updated when the source eNB 320₁ receives new status messages, or when it receives Local ACK/NACK messages from HARQ.

The RLC Tx at the target eNB 320₂ may use of some or all of the above RLC Tx context information to efficiently transmit new data, and/or efficiently retransmit data. For example, the RLC Tx may use the Octet identifier or the PDU identifier in order to continue transmission from the point where the source eNB 320₁ has stopped, instead of inefficiently and unnecessarily transmitting the whole SDU, parts of which were transmitted by the source eNB 320₁ already.

Also, the RLC Tx at the target eNB 320₂ may make use of the per-SDU acknowledgement status to identify the SDUs it needs to transmit or retransmit, instead of inefficiently and unnecessarily retransmitting some SDUs that have been previously acknowledged. Additionally, the RLC Tx at the target eNB 320₂ may make use of the per-PDU acknowledgement status, and possibly the segmentation information to translate or map or resolve the status messages it will receive from the WTRU 310, and identify which parts of an SDU it needs to retransmit, instead retransmitting a bigger portion of the SDU or the whole SDU, which may be inefficient and unnecessary.

For the UL traffic case, when the RLC Rx side resides in the eNB, the context information may include one or more of the following for each MAC-ID flow (or logical channel ID):
a) The “Sequence Number” following that of the last in-sequence SDU received.
b) For each SDU which is not completely received, The PDU “identifier” (e.g., “Sequence Number” or “Segment Number”), following that of the last in-sequence PDU received.
c) For each SDU which is not completely received, The Octet “identifier”, (e.g., “Octet/Byte Number”, following that of the last in-sequence octet received). (e.g. a pointer to an octet in the last in-sequence SDU being currently received, or in the last in-sequence SDU completely received).
d) The “Sequence Number” following the highest “Sequence Number” of any received SDU.
e) For each SDU which is not completely received, the PDU “identifier” (e.g., “Sequence Number” or “Segment Number”) following the highest PDU “identifier” of any received PDU.
f) For each SDU which is not completely received, the Octet “identifier” (e.g., “Octet/Byte Number”), following the highest octet “identifier” of any received octet.
g) Per-SDU reception status for each SDU with sequence number between those in (a) and (d). (i.e. the status of whether an SDU is correctly received or not).
h) For each SDU which is not completely received, Per-PDU reception status for each PDU with “identifier” e.g. “Sequence Number” or “Segment Number” between those in (b) and (e). (i.e. status of whether an PDU is correctly received or not).
i) Per-Octet-Range reception status for each Octet-Range with Octet “identifier” e.g. “Octet/Byte Number” between those in points (c) and (f). (i.e. the status of whether an octet-range is correctly received or not).

The above context information can be transferred multiple times, initially and anytime the context information is updated when the source eNB 320₁ receives RLC PDUs. For example, Per-SDU reception status for each SDU with sequence number between those, such as the status of whether an SDU is correctly received or not.

In the case where PDU header does not contain SDU information, the context should contain the last correctly received PDU “identifier”, (e.g., “Sequence Number” following the “identifier” of the last in-sequence acknowledged PDU), the PDU “identifier” (e.g., “Sequence Number” of the next PDU to be received for the first time and the “Sequence Number” of all the PDUs correctly received.

The RLC Rx at the target eNB 320₂ may make use of some or all of the above RLC Rx context information to create status messages or any other messages that will be sent to the WTRU 310 to update the WTRU's RLC context. The WTRU 310 may utilize such messages to update any part of its RLC context, for example, to update the RLC Tx context in order to efficiently use the wireless medium by avoiding unnecessary retransmitting packets (e.g. SDUs).

In addition to the above, any of the RLC Tx, RLC Rx, RLC timers, or RLC configuration parameters context information such as those similar to those previously described may be transferred.

In an RLC SDU and RLC PDU data forwarding scenario, the data forwarding between eNB's is done at the SDU-level and at the PDU-level, where the source eNB 320₁ forwards both the RLC SDUs and the RLC PDUs as data.

During a handover scenario, for UL traffic when the RLC Rx side resides in the eNB, the source eNB 320₁ forwards to either the target eNB 320₂ or the node containing the MME/UPE all the SDUs that have been received from the WTRU 310. Additionally, the source eNB 320₁ forwards to the target eNB 320₂ all the PDUs that have been received from the WTRU 310 and have not been completely assembled into SDUs.

Alternatively, the source eNB 320₁ forwards to the target eNB 320₂ all the PDUs that have been received from the WTRU 310 and have not been completely assembled into SDUs and the source eNB 320₁ does not forward SDUs to the target eNB 320₂, but forwards them instead to the node containing the MME/UPE all the SDUs. The source eNB 320₁ can still transfer the context information at any level, (e.g., at the SDU-level and/or finer-levels), to the target eNB 320₂.

For DL traffic where the RLC Tx side resides in the NB, the source eNB 320₁ forwards to the target eNB 320₂ all the SDUs and PDUs that have not been fully transmitted to the WTRU 310 and the source eNB 320₁ forwards to the target eNB 320₂ all the SDUs and PDUs that have not been fully acknowledged by the WTRU 310.

In another example, context transfer in the RLC SDU+PDU data forwarding may be facilitated. This generally includes the synthesis and transfer of PDU-level context information, in addition to the SDU-level context information, whereby the context is described at the PDU-level and at the SDU-level. Also, it includes the synthesis and transfer of Octet-level context information and/or PDU-level context information, in addition to the SDU-level context information, whereby the context is described at the Octet-level and/or at the PDU-level and/or at the SDU-level.

For transfer of SDU-level RLC Context and PDU-level RLC Context and possibly Octet-level RLC Context, the source eNB 320₁ transfers SDU-level context information and the PDU-level context information to the target eNB 320₂, possibly together with some octet-level context information. This transfer may occur in different ways, For example, the source eNB 320₁ can explicitly communicate the context information to the target eNB 320₂, via the use of context transfer messages or signals. Alternatively, the target eNB 320₂ may extract or construct the context information from the data packets it receives from the source eNB 320₁, (for example, the target eNB 320₂ can examine the RLC PDU headers and construct the necessary context information).

In another alternative embodiment, the source eNB 320₁ can forward RLC SDUs and/or RLC PDUs to the target eNB 320₂. During context transfer between source eNB 320₁ and target eNB 320₂, for the uplink direction, the source eNB 320₁ sends the target eNB 320₂ one or more of the following information:
Number of MAC flow IDs or logical channel identity. PDCP or Common SN of Last RLC SDUs (received in Sequence) that was sent to the aGW). It denotes the PDCP or common SN of the last packet received by the gateway not necessarily from the current eNB. It will cover ping pong affect in Handover (if any).
Complete RLC SDUs received out of sequence.
Incomplete RLC SDUs received: In that case, the following information should be sent:
   Number of incomplete RLC SDUs.
   For each RLC SDU, the details of correctly received RLC PDUs and missing PDUs. There are different methods of passing this information to the target eNB 320₂:
      Send all the RLC PDUs. Layer 2 should use the header information in RLC PDUs to reassemble the packet at the target eNB 320₂; or
      The source eNB 320₁ sends RLC SDU SN, RLC PDU index in the RLC SDU packet and length indicator for each RLC PDU received with RLC PDU payload.

For downlink packets, the source eNB 320₁ sends the target eNB 320₂ the following context information:
Number of Mac flow IDs/logical channel IDs.
For each MAC/logical channel ID.
   Sequence Number of the last RLC SDU acknowledged by the WTRU 310.
   For RLC SDUs whose transmission has not started:
      Number of such RLC SDUs.
      RLC SDUs and SN associated with it.
   For RLC SDUs that have been partially transmitted by the source eNB 320₁:
      Number of such RLC SDUs.
   For each RLC SDU, the details on correctly transmitted RLC PDUs and missing PDUs. There are different methods of passing this information to the target eNB 320₂:
      Send all the RLC PDUs not transmitted successfully. Layer 2 should use the header information in RLC PDUs to retransmit the packet from the target eNB 320₂;
      Send RLC SDU SN, RLC PDU index in the RLC SDU packet and length indicator for each RLC PDU not transmitted successfully, RLC PDU payload; or
      Send RLC SDU, RLC SDU SN and RLC PDU index in the RLC SDU packet and length indicator for each RLC PDU not transmitted.

When the source eNB 320₁ sends the HO command to the WTRU 310 it should also include information about the ARQ control packet either multiplexed with RLC packets or sent as a separate MAC packet. The source eNB 320₁ sends an ARQ control packet to the WTRU 310 for each MAC flow/logical channel. The ARQ control packet contains uplink data flow information, downlink data flow information, and control information relating to the handover.

The uplink data flow information includes the SN of the last complete RLC SDU received in sequence, the SN of complete RLC SDUs received out of sequence, and the SN of incomplete RLC SDUs received, for each RLC SDU. The SN of incomplete RLC SDUs received, for each RLC SDU further includes the RLC PDU identity, which is its place in the RLC SDU, and a length indicator.

The downlink data flow information includes the last RLC SDU transmitted successfully in sequence to the WTRU 310, complete RLC SDUs transmitted successfully out of sequence to the WTRU 310, the SN of incomplete RLC SDUs transmitted, for each RLC SDU, the RLC PDU identity (its place in RLC SDU), and the length indicator.

Control information related to the handover includes a suspend command for transmit and RLC receiver. This ensures that the RLC does not transmit any user or control packet after this step. Also, it will reset or suspend any timers associated with status reporting or request.

The WTRU 310 may send a control packet reporting its status to the source eNB 320₁. It will contain context information similar to above in the description of Transfer of SDU-level RLC Context and PDU-level RLC Context and Octet-level RLC Context about successfully received and transmitted downlink and uplink packets.

During context transfer between the target eNB 320₂ and WTRU 310, the target eNB 320₂ sends an ARQ control packet to the WTRU 310 for each MAC flow/logical Channel. The ARQ control packet here also contains uplink data flow information, downlink data flow information, and control information relating to the handover.

The uplink data flow information includes the SN of the last complete RLC SDU received in sequence as indicated by the source eNB 320₁, the SN of complete RLC SDUs received out of sequence as indicated by the source eNB 320₁, and the SN of incomplete RLC SDUs received, for each RLC SDU as indicated by the source eNB 320₁, which further includes the RLC PDU identity (its place in RLC SDU), and the length indicator.

The downlink data flow information includes the last RLC SDU transmitted successfully in sequence to the WTRU 310 as indicated by the source eNB 320₁, the complete RLC SDUs transmitted successfully out of sequence to the WTRU 310 as indicated by the source eNB 320₁, the SN of incomplete RLC SDUs transmitted, for each RLC SDU as indicated by the source eNB 320₁, which also RLC PDU identity (its place in RLC SDU), and the length indicator.

Control information related to handover includes the resume command for the RLC Tx and Rx. This ensures that the RLC starts transmitting user or control packet to target eNB 320₂. Also, it will set or resume any timers associated with status reporting or request, and the like.

The WTRU 310 may send a control packet reporting its status to the source eNB 320₁. The packet contains context information similar to the items described above in the description of Transfer of SDU-level RLC Context and PDU-level RLC Context and Octet-level RLC Context about successfully received and transmitted downlink and uplink packet respectively for each MAC/logical flow.

The processors 415/425 of the WTRU 310 or the eNBs 320, respectively, may be configured to perform the steps of the methods described above. The processors 15/425 may also utilize the receivers 416/426, transmitters 417/427, and antennas 418/428, respectively, to facilitate wirelessly receiving and transmitting data.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. In a wireless communication system comprising at least one wireless transmit/receive unit (WTRU), a source evolved Node B (eNB), a target eNB, and a mobility management entity/user plane entity (MME/UPE) the WTRU in wireless communication with the source eNB, a method for facilitating lossless handover, the method comprising:
(a) the source eNB determining to handover the WTRU to the target eNB 320₂;
(b) the source eNB requesting a status report from the WTRU;
(c) the source eNB requesting handover to the target eNB wherein the handover request includes sending context information relating to the WTRU to the target eNB;
(d) the target eNB configuring resources for the WTRU and transmitting a handover response signal to the source eNB;
(e) the source eNB commanding the WTRU to perform a handover to the target eNB and forwarding data to the target eNB; and
(f) the WTRU performing the handover to the target eNB.

2. The method of claim 1, further comprising the source eNB commanding the WTRU to cease data transmission to the source eNB.

3. The method of claim 1, further comprising the source eNB sending an uplink (UL) radio link controller (RLC) context report to the WTRU.

4. The method of claim 3, further comprising the WTRU sending a downlink (DL) RLC context report to the source eNB.

5. The method of claim 1 wherein step (e) further comprises the source eNB buffering forwarded data.

6. The method of claim 1, further comprising the target eNB buffering data in the DL.

7. The method of claim 1, further comprising the WTRU synchronizing with the target eNB.

8. The method of claim 1, further comprising the MME/UPE switching the data path of the WTRU from the source eNB to the target eNB.

9. The method of claim 1, further comprising the target eNB segmenting data.

10. The method of claim 9 wherein the target eNB segments the data based on information received from the source eNB.

11. The method of claim 9 wherein the target eNB segments the data based on the wireless link quality between the target eNB and the WTRU.

12. The method of claim 1, further comprising releasing resources in the network served by the source eNB.

13. The method of claim 12 wherein the released resources include any one of the following: radio resources, context resource, and transport network layer (TNL) resources.

14. The method of claim 1, further comprising the WTRU registering with the MME/UPE.

15. The method of claim 14, further comprising the MME/UPE updating area restriction information in the cell served by the target eNB.

16. The method of claim 1 wherein the source eNB sends the context information to the target eNB concurrently with the WTRU performing the handover.

17. The method of claim 1 wherein the context information includes information selected from the group consisting of: security parameters, mobile station (MS) network capability, MS class capability, discontinuous reception (DRX) parameters, radio access bearer (RAB) configuration parameters, and session management parameters.

18. The method of claim 1 wherein the context information includes radio link controller (RLC) context information.

19. The method of claim 18 wherein RLC context information includes information selected from the group consisting of: an RLC transmitter (Tx), an RLC receiver (Rx), an RLC timer, and RLC configuration parameters.

20. The method of claim 1, further comprising the source eNB forwarding RLC service data units (SDUs) to the target eNB.

21. The method of claim 20 wherein the source eNB forwards to the target eNB information selected from the group consisting of: the number of medium access control (MAC) flow IDs, complete RLC SDUs received out of sequence, and incomplete RLC SDUs received.

22. The method of claim 1, further comprising the source eNB forwarding RLC packet data units (PDUs) to the target eNB.

23. In a wireless communication system comprising at least one wireless transmit/receive unit (WTRU), at least one evolved Node B (eNB), and a mobility management entity/user plane entity (MME/UPE), the eNB comprising:
a receiver;
a transmitter; and
a processor in communication with the receiver and the transmitter, the processor configured to determine to handover the WTRU from the eNB to a target eNB, request a status report from the WTRU, request handover to the target eNB, send context information relating to the WTRU to the target eNB, command the WTRU to perform a handover to the target eNB, and forward data to the target eNB.

24. The eNB of claim 23 wherein the processor is further configured to command the WTRU to cease data transmission to the eNB.

25. The eNB of claim 24 wherein the processor is further configured to send an uplink (UL) radio link controller (RLC) context report to the WTRU.

26. The eNB of claim 23 wherein the processor is further configured to buffer forwarded data.

27. The eNB of claim 23 wherein the processor is further configured to release resources in the cell associated with the eNB.

28. The eNB of claim 27 wherein the released resources include any one of the following: radio resources, context resource, and transport network layer (TNL) resources.
